(19) United States
(12) Patent Application Publication
(10) Pub. No.: US 2022/0351398 A1
(43) Pub. Date: Nov. 3, 2022

(54) DEPTH DETECTION METHOD, METHOD FOR TRAINING DEPTH ESTIMATION BRANCH NETWORK, ELECTRONIC DEVICE, AND STORAGE MEDIUM

(71) Applicant: Beijing Baidu Netcom Science Technology Co., LTD., Beijing (CN)

(72) Inventors: Zhikang Zou, Beijing (CN); Xiaoqing Ye, Beijing (CN); Hao Sun, Beijing (CN)

(21) Appl. No.: 17/813,870

(22) Filed: Jul. 20, 2022

(30) Foreign Application Priority Data
Sep. 29, 2021 (CN) 202111155117.3

(51) Int. Cl. G06T 7/50; G06T 7/73

(52) U.S. Cl. CPC G06T 7/50; G06T 7/74; G06T 2207/20084; G06T 2207/20081

(57) ABSTRACT

A depth detection method, a method for training a depth estimation branch network, an electronic device, and a storage medium are provided, which relate to the field of artificial intelligence, particularly to the technical fields of computer vision and deep learning, and may be applied to intelligent robot and automatic driving scenarios. The specific implementation includes: extracting a high-level semantic feature in an image to be detected, wherein the high-level semantic feature is used to represent a target object in the image to be detected; inputting the high-level semantic feature into a pre-trained depth estimation branch network, to obtain distribution probabilities of the target object in respective sub-intervals of a depth prediction interval; and determining a depth value of the target object according to the distribution probabilities of the target object in the respective sub-intervals and depth values represented by the respective sub-intervals.

### CROSS-REFERENCE TO RELATED APPLICATION

This application claims priority to Chinese patent application No. 202111155117.3, filed on Sep. 29, 2021, which is hereby incorporated by reference in its entirety.

### TECHNICAL FIELD

The present disclosure relates to the field of artificial intelligence, particularly to the technical fields of computer vision and deep learning, and may be applied to intelligent robot and automatic driving scenarios.

### BACKGROUND

Monocular three-dimensional (3D) detection mainly relies on the prediction of key points projected from a 3D object onto a two-dimensional (2D) image, and then a real 3D bounding box of the object is recovered by predicting 3D attributes (length, width, height) and a depth value of the object, so as to complete the 3D detection task.

### SUMMARY

The present disclosure provides a depth detection method, an apparatus, a device, and a storage medium.

According to an aspect of the present disclosure, there is provided a depth detection method, including:

extracting a high-level semantic feature in an image to be detected, wherein the high-level semantic feature is used to represent a target object in the image to be detected;

inputting the high-level semantic feature into a pre-trained depth estimation branch network, to obtain distribution probabilities of the target object in respective sub-intervals of a depth prediction interval; and

determining a depth value of the target object according to the distribution probabilities of the target object in the respective sub-intervals and depth values represented by the respective sub-intervals.

According to another aspect of the present disclosure, there is further provided a method for training a depth estimation branch network, including:

acquiring an actual distribution probability of a target object in a sample image;

performing feature extraction processing on the sample image, to obtain a high-level semantic feature of the sample image;

inputting the high-level semantic feature of the sample image into a depth estimation branch network to be trained, to obtain a predicted distribution probability of the target object represented by the high-level semantic feature; and

determining a difference between the predicted distribution probability and the actual distribution probability of the sample image, and adjusting, according to the difference, a parameter of the depth estimation branch network to be trained, until the depth estimation branch network to be trained converges.

It should be understood that the content described in this section is neither intended to limit the key or important features of the embodiments of the present disclosure, nor intended to limit the scope of the present disclosure. Other features of the present disclosure will be readily understood through the following description.

### BRIEF DESCRIPTION OF THE DRAWINGS

The drawings are used to better understand the solution and do not constitute a limitation to the present disclosure. In which:

FIG. 1 is a flowchart of a depth detection method according to an embodiment of the present disclosure;

FIG. 2 is a specific flowchart of dividing sub-intervals according to a depth detection method of an embodiment of the present disclosure;

FIG. 3 is a specific flowchart of determining a depth value represented by a sub-interval according to a depth detection method of an embodiment of the present disclosure;

FIG. 4 is a specific flowchart of determining a depth value of a target object according to a depth detection method of an embodiment of the present disclosure;

FIG. 5 is a specific flowchart of feature extraction according to a depth detection method of an embodiment of the present disclosure;

FIG. 6 is a flowchart of a method for training a depth estimation branch network according to an embodiment of the present disclosure;

FIG. 7 is a block diagram of a target detection apparatus according to an embodiment of the present disclosure;

FIG. 8 is a block diagram of an apparatus for training a depth estimation branch network according to an embodiment of the present disclosure; and

FIG. 9 is a block diagram of an electronic device for implementing a depth detection method and/or a method for training a depth estimation branch network according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

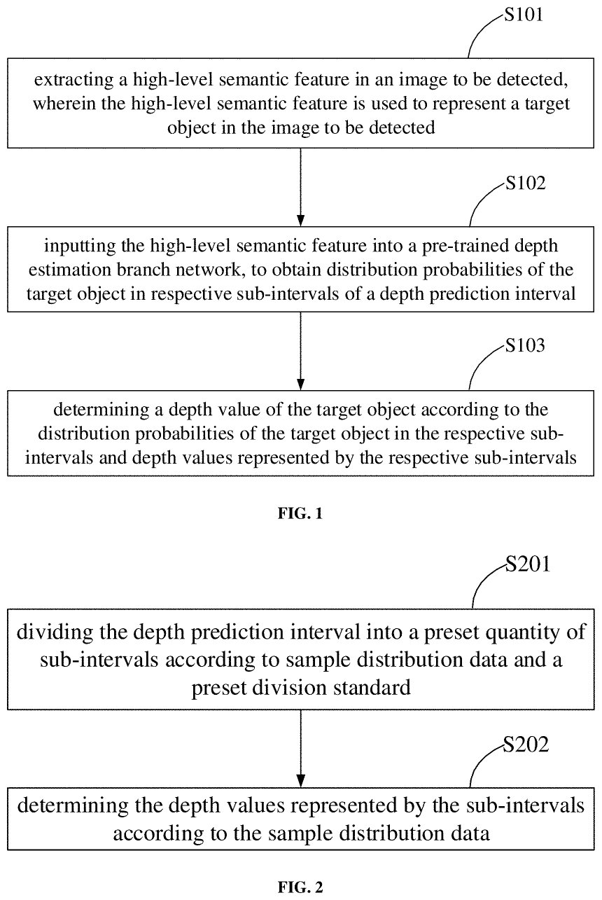

The depth detection method according to the embodiments of the present disclosure is described below with reference to FIG. 1 to FIG. 5.

As shown in FIG. 1, the depth detection method according to the embodiments of the present disclosure includes:

S101: extracting a high-level semantic feature in an image to be detected, wherein the high-level semantic feature is used to represent a target object in the image to be detected;

S102: inputting the high-level semantic feature into a pre-trained depth estimation branch network, to obtain distribution probabilities of the target object in respective sub-intervals of a depth prediction interval; and

S103: determining a depth value of the target object according to the distribution probabilities of the target object in the respective sub-intervals and depth values represented by the respective sub-intervals.

According to the depth detection method of the present disclosure, a prediction task of the depth value may be converted into a classification task through a designed depth estimation branch network with adaptive depth distribution, that is, distribution probabilities of the target object in the respective sub-intervals of the depth prediction interval are predicted, and the depth prediction accuracy is greatly improved according to the depth value represented by the respective sub-intervals, which is beneficial to improving 3D positioning accuracy in the application of 3D object detection for images.

The method in the embodiments of the present disclosure may be used to detect depth information in the image to be detected. Herein, the image to be detected may be a monocular visual image, and the monocular visual image may be collected by using a monocular visual sensor.

Illustratively, in S101, the high-level semantic feature in the image to be detected may be obtained through performing feature extraction by a feature extraction layer of a 3D detection model. Herein, the feature extraction layer may include a plurality of convolutional layers. After layer-by-layer extraction of the plurality of convolutional layers, the high-level semantic feature in the image to be detected is finally output from a deep convolutional layer.

Illustratively, in S102, the depth estimation branch network outputs the distribution probabilities of the target object in respective sub-intervals of the depth prediction interval according to the input high-level semantic feature. Herein, the depth prediction interval refers to a preset maximum depth measurement range. The depth prediction interval is pre-divided into a plurality of sub-intervals, and the plurality of sub-intervals may be continuous or intermittent.

Herein, the distribution probabilities of the target object in the respective sub-intervals may be understood as the probabilities that the target object is located in the respective sub-intervals, that is, each of the respective sub-intervals corresponds to a probability value.

The depth estimation branch network may adopt various classification networks known to those skilled in the art or known in the future, for example, the VGG Net (Visual Geometry Group Net, a classification network), the ResNet (Residual Neural Network, a residual error classification network), the ResNeXt (a combined network of ResNet and Inception), the SE-Net (an image recognition classification network) and other classification networks.

Illustratively, in S103, the depth value of the target object may be obtained by summing the products of the distribution probabilities of the target object in the respective sub-intervals and the depth values represented by the respective sub-intervals.

In a specific example, the depth prediction interval may be 70 m, and the entire depth prediction interval is divided into a preset quantity of sub-intervals, e.g., (0-a, a-b, . . . , −70 m), according to preset division conditions. According to the extracted high-level semantic feature, the depth estimation branch network outputs the distribution probabilities that the target object is located in the respective sub-intervals, represented by the high-level semantic feature, and the sum of the distribution probabilities corresponding to the respective sub-intervals is 1. Finally, the depth value of the target object may be obtained by summing weights of all sub-intervals. Herein, a weighted value corresponding to each sub-interval is a depth value represented by each sub-interval.

It should be noted that the depth estimation branch network may be a branch network of the 3D detection model.

In an example, the 3D detection model may include a feature extraction layer, a depth estimation branch network, a 2D head network, a 3D head network, and an output network. The feature extraction layer is used to perform feature extraction processing on an input image to be detected, to obtain the high-level semantic feature of the image to be detected. The 2D head network outputs, according to the high-level semantic feature, classification information and position information of the target object in the image to be detected. The 3D head network outputs, according to the high-level semantic feature, size information and angle information of the target object in the image to be detected. The depth estimation branch network outputs, according to the high-level semantic feature, the depth value of the target object in the image to be detected. Finally, the output network of the 3D detection model obtains, according to the above information, a prediction frame and related information of the target object in the image to be detected.

Herein, the 3D detection model may specifically be a model for performing 3D object detection on a monocular image, which may be applied to intelligent robot and automatic driving scenarios.

According to the depth detection method of the present disclosure, a prediction task of the depth value may be converted into a classification task by a designed depth estimation branch network with adaptive depth distribution, that is, distribution probabilities of the target object in the respective sub-intervals of the depth prediction interval are predicted, and the depth value of the target object obtained according to the depth value represented by the respective sub-intervals is more accurate, which is beneficial to improving 3D positioning accuracy in the application of 3D detection for images.

As shown in FIG. 2, in an implementation, the method further includes:

S201: dividing the depth prediction interval into a preset quantity of sub-intervals according to sample distribution data and a preset division standard, wherein the sample distribution data includes depth values of a plurality of samples within the depth prediction interval; and

S202: determining the depth values represented by the sub-intervals according to the sample distribution data.

Illustratively, the sample distribution data may be a training sample set used in the training process of the depth estimation branch network. The training sample set includes a plurality of sample images, and each of the sample images includes a target object frame and an actual depth value of the target object frame.

Illustratively, in S201, the preset division standard may be specifically set according to actual situations, for example, a preset quantity of sub-intervals of equal length may be divided in the depth prediction interval, and also a plurality of sub-intervals with approximately equal distribution densities may be divided according to distribution densities of respective target object frames of the training sample set in the depth prediction interval.

Illustratively, in S202, according to length values of a plurality of sub-intervals divided in the depth prediction interval, the depth value represented by the sub-interval may be obtained by calculating an average value of length values of the respective sub-intervals. Alternatively, the depth value represented by the sub-interval is obtained by calculating an average value of depth values of the target objects distributed in the sub-intervals.

According to the above implementation, the depth prediction interval may be reasonably divided into a plurality of sub-intervals by using a prior part of the sample distribution data to divide the depth prediction interval and determining the depth value represented by each sub-interval, and the depth value represented by each sub-interval may also be determined according to the prior part of the sample distribution data, so as to ensure that the finally obtained depth value of the target object has high accuracy.

In an implementation, the preset division standard includes:

for any sub-interval, a product of a depth range of the sub-interval and a quantity of samples distributed in the sub-interval conforms to a preset value range.

Illustratively, the depth range of the sub-interval refers to a length range of the sub-interval, and the preset value range may be an interval range in which a preset constant value fluctuates. The product of the depth range of the sub-interval and the quantity of samples distributed in the sub-interval conforms to the preset value range, which may be understood as the product of the depth range of the sub-interval and the quantity of the samples distributed in the sub-interval approximately approaching a preset constant value.

According to the above implementation, the depth ranges of the respective sub-intervals may be adaptively and reasonably divided to ensure that sub-interval division of an area with relatively dense sample distribution is also relatively dense, so that for an area with dense sample distribution, the division accuracy of sub-intervals may be effectively improved to ensure that the finally obtained depth value is more accurate.

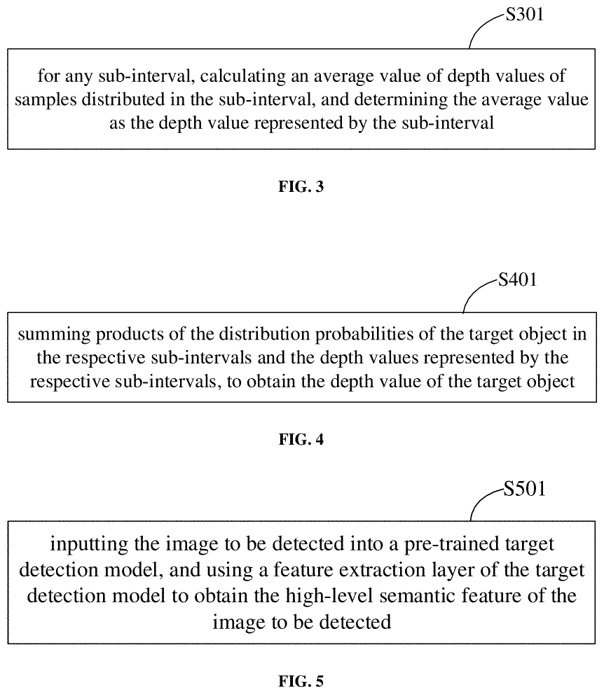

As shown in FIG. 3, in an implementation, S202 includes:

S301: for any sub-interval, calculating an average value of depth values of samples distributed in the sub-interval, and determining the average value as the depth value represented by the sub-interval.

It may be understood that, for any sub-interval, the distribution of samples in the sub-interval is random. By calculating the average value of depth values of a plurality of samples distributed in the sub-interval, and determining the average value as the depth value represented by the sub-interval, the depth value represented by the sub-interval may be in better conformity with the actual distribution of the sample, improving the predictability of the depth value represented by the sub-interval, so that the finally obtained depth value more accurate.

As shown in FIG. 4, in an implementation, S103 includes:

S401: summing products of the distribution probabilities of the target object in the respective sub-intervals and the depth values represented by the respective sub-intervals, to obtain the depth value of the target object.

Illustratively, after the distribution probabilities of the target object in the respective sub-intervals are obtained by using the depth estimation branch network, combined with the depth values represented by the preset respective sub-intervals, the depth value D of the target object may be calculated by the following formula:

D=ΣPᵢDᵢ,

wherein Pᵢ is used to represent a distribution probability of the target object in an i-th sub-interval, and Dᵢ is used to represent a depth value represented by the i-th sub-interval.

According to the above implementation, the process of calculating the depth value of the target object is relatively simple according to the distribution probabilities of the target object in the respective sub-intervals and the depth values represented by the respective sub-intervals, and the finally obtained depth value conforms to the accuracy of probability distribution.

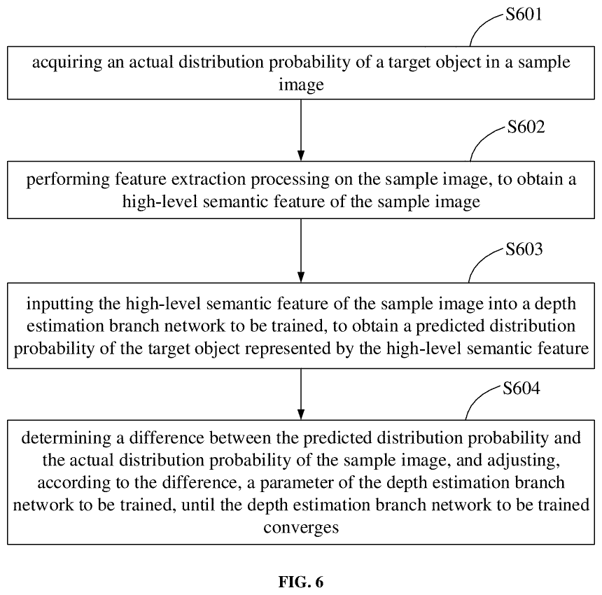

As shown in FIG. 5, in an implementation, S101 includes:

S501: inputting the image to be detected into a pre-trained target detection model, and using a feature extraction layer of the target detection model to obtain the high-level semantic feature of the image to be detected.

Illustratively, the feature extraction layer of the target detection model may use a plurality of convolutional layers to perform feature extraction processing on the image to be detected, and after layer-by-layer extraction of the plurality of convolutional layers, finally, the high-level semantic feature is output by a deep convolutional layer.

According to the above implementation, the feature extraction layer of the target detection model may be used to directly extract the high-level semantic feature of the image to be detected, and the depth information output by the depth estimation branch network may be used as the input of an output layer of the target detection model. Finally, combined with the information output by each branch network, a 3D detection result of the image to be detected is obtained.

According to the embodiments of the present disclosure, there is further provided a method for training a depth estimation branch network.

As shown in FIG. 6, the method for training a depth estimation branch network includes:

S601: acquiring an actual distribution probability of a target object in a sample image;

S602: performing feature extraction processing on the sample image, to obtain a high-level semantic feature of the sample image;

S603: inputting the high-level semantic feature of the sample image into a depth estimation branch network to be trained, to obtain a predicted distribution probability of the target object represented by the high-level semantic feature; and

S604: determining a difference between the predicted distribution probability and the actual distribution probability of the sample image, and adjusting, according to the difference, a parameter of the depth estimation branch network to be trained, until the depth estimation branch network to be trained converges.

Illustratively, the actual distribution probability of the target object in the sample image may be determined by manual labeling or machine labeling.

Illustratively, a feature extraction layer of a pre-trained 3D detection model may be used to perform feature extraction processing on the sample image.

Illustratively, in S603, a preset loss function may be used to calculate and obtain a difference between the predicted distribution probability and the actual distribution probability of the sample image. In addition, the parameter of the depth estimation branch network is adjusted based on the loss function.

According to the method for training a depth estimation branch network in the embodiments of the present disclosure, predicted distribution probabilities of the target object in the respective sub-intervals of the depth detection interval may be obtained by training, and the obtained depth estimation branch network has high prediction accuracy.

According to the embodiments of the present disclosure, there is further provided a target detection apparatus.

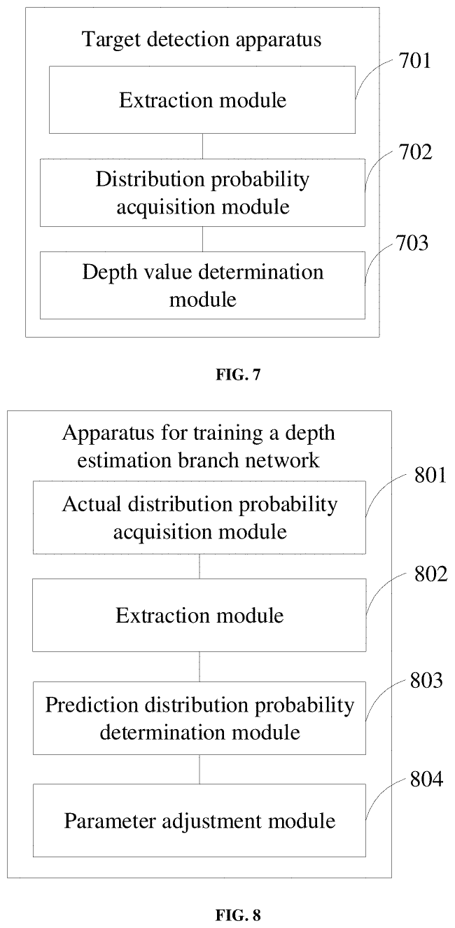

As shown in FIG. 7, the apparatus includes:

an extraction module 701 configured for extracting a high-level semantic feature in an image to be detected, wherein the high-level semantic feature is used to represent a target object in the image to be detected;

a distribution probability acquisition module 702 configured for inputting the high-level semantic feature into a pre-trained depth estimation branch network, to obtain distribution probabilities of the target object in respective sub-intervals of a depth prediction interval; and

a depth value determination module 703 configured for determining a depth value of the target object according to the distribution probabilities of the target object in the respective sub-intervals and depth values represented by the respective sub-intervals.

In an implementation, the apparatus further includes:

a sub-interval division module configured for dividing the depth prediction interval into a preset quantity of sub-intervals according to sample distribution data and a preset division standard, wherein the sample distribution data includes depth values of a plurality of samples within the depth prediction interval; and

a sub-interval depth value determination module configured for determining the depth values represented by the sub-intervals according to the sample distribution data.

In an implementation, the preset division standard includes:

for any sub-interval, a product of a depth range of the sub-interval and a quantity of samples distributed in the sub-interval conforms to a preset value range.

In an implementation, the depth value determination module 703 is further configured for:

for any sub-interval, calculating an average value of depth values of samples distributed in the sub-interval, and determining the average value as the depth value represented by the sub-interval.

In an implementation, the depth value determination module 703 is further configured for:

summing products of the distribution probabilities of the target object in the respective sub-intervals and the depth values represented by the respective sub-intervals, to obtain the depth value of the target object.

In an implementation, the extraction module 701 is further configured for:

inputting the image to be detected into a pre-trained target detection model, and using a feature extraction layer of the target detection model to obtain the high-level semantic feature of the image to be detected.

According to the embodiments of the present disclosure, there is further provided an apparatus for training a depth estimation branch network.

As shown in FIG. 8, the apparatus includes:

an actual distribution probability acquisition module 801 configured for acquiring an actual distribution probability of a target object in a sample image;

an extraction module 802 configured for performing feature extraction processing on the sample image, to obtain a high-level semantic feature of the sample image;

a prediction distribution probability determination module 803 configured for inputting the high-level semantic feature of the sample image into a depth estimation branch network to be trained, to obtain a predicted distribution probability of the target object represented by the high-level semantic feature; and

a parameter adjustment module 804 configured for determining a difference between the predicted distribution probability and the actual distribution probability of the sample image, and adjusting, according to the difference, a parameter of the depth estimation branch network to be trained, until the depth estimation branch network to be trained converges.

In the technical solution of the present disclosure, the acquisition, storage and application of the user's personal information involved are in compliance with the provisions of relevant laws and regulations, and do not violate public order and good customs.

According to embodiments of the present disclosure, the present disclosure also provides an electronic device, a readable storage medium, and a computer program product.

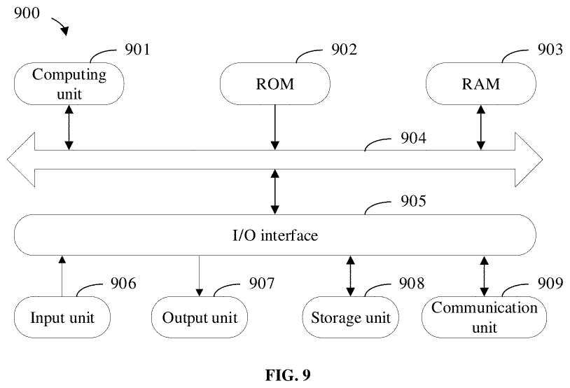

FIG. 9 shows a schematic block diagram of an example electronic device 900 that may be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 9, the electronic device 900 includes a computing unit 901 that may perform various suitable actions and processes in accordance with computer programs stored in a read only memory (ROM) 902 or computer programs loaded from a storage unit 908 into a random access memory (RAM) 903. In the RAM 903, various programs and data required for the operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the electronic device 900 to exchange information/data with other devices over a computer network, such as the Internet, and/or various telecommunications networks.

The computing unit 901 may be various general purpose and/or special purpose processing assemblies having processing and computing capabilities. Some examples of the computing unit 901 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 901 performs various methods and processes described above, such as the depth detection method and/or the method for training a depth estimation branch network. For example, in some embodiments, the depth detection method and/or the method for training a depth estimation branch network may be implemented as computer software programs that are physically contained in a machine-readable medium, such as the storage unit 908. In some embodiments, some or all of the computer programs may be loaded into and/or installed on the electronic device 900 via the ROM 902 and/or the communication unit 909. In a case where the computer programs are loaded into the RAM 903 and executed by the computing unit 901, one or more of steps of the depth detection method and/or the method for training a depth estimation branch network described above may be performed. Alternatively, in other embodiments, the computing unit 901 may be configured to perform the depth detection method and/or the method for training a depth estimation branch network in any other suitable manner (e.g., by means of a firmware).

Various embodiments of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other. The server can be a cloud server, a distributed system server, or a server combined with a blockchain.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

What is claimed is:

1. A depth detection method, comprising:
extracting a high-level semantic feature in an image to be detected, wherein the high-level semantic feature is used to represent a target object in the image to be detected;
inputting the high-level semantic feature into a pre-trained depth estimation branch network, to obtain distribution probabilities of the target object in respective sub-intervals of a depth prediction interval; and
determining a depth value of the target object according to the distribution probabilities of the target object in the respective sub-intervals and depth values represented by the respective sub-intervals.

2. The method of claim 1, further comprising:
dividing the depth prediction interval into a preset quantity of sub-intervals according to sample distribution data and a preset division standard, wherein the sample distribution data comprises depth values of a plurality of samples within the depth prediction interval; and
determining the depth values represented by the sub-intervals according to the sample distribution data.

3. The method of claim 2, wherein the preset division standard comprises:
for any sub-interval, a product of a depth range of the sub-interval and a quantity of samples distributed in the sub-interval conforms to a preset value range.

4. The method of claim 2, wherein the determining the depth values represented by the sub-intervals according to the sample distribution data, comprises:
for any sub-interval, calculating an average value of depth values of samples distributed in the sub-interval, and determining the average value as the depth value represented by the sub-interval.

5. The method of claim 1, wherein the determining the depth value of the target object according to the distribution probabilities of the target object in the respective sub-intervals and the depth values represented by the respective sub-intervals, comprises:
summing products of the distribution probabilities of the target object in the respective sub-intervals and the depth values represented by the respective sub-intervals, to obtain the depth value of the target object.

6. The method of claim 1, wherein the extracting the high-level semantic feature in the image to be detected, comprises:
inputting the image to be detected into a pre-trained target detection model, and using a feature extraction layer of the target detection model to obtain the high-level semantic feature of the image to be detected.

7. A method for training a depth estimation branch network, comprising:
acquiring an actual distribution probability of a target object in a sample image;
performing feature extraction processing on the sample image, to obtain a high-level semantic feature of the sample image;
inputting the high-level semantic feature of the sample image into a depth estimation branch network to be trained, to obtain a predicted distribution probability of the target object represented by the high-level semantic feature; and
determining a difference between the predicted distribution probability and the actual distribution probability of the sample image, and adjusting, according to the difference, a parameter of the depth estimation branch network to be trained, until the depth estimation branch network to be trained converges.

8. An electronic device, comprising:
at least one processor; and
a memory communicatively connected with the at least one processor, wherein
the memory stores instructions executable by the at least one processor, and the instructions, when executed by the at least one processor, enable the at least one processor to perform operations of:
extracting a high-level semantic feature in an image to be detected, wherein the high-level semantic feature is used to represent a target object in the image to be detected;
inputting the high-level semantic feature into a pre-trained depth estimation branch network, to obtain distribution probabilities of the target object in respective sub-intervals of a depth prediction interval; and
determining a depth value of the target object according to the distribution probabilities of the target object in the respective sub-intervals and depth values represented by the respective sub-intervals.

9. The electronic device of claim 8, wherein the instructions, when executed by the at least one processor, enable the at least one processor to further perform operations of:
dividing the depth prediction interval into a preset quantity of sub-intervals according to sample distribution data and a preset division standard, wherein the sample distribution data comprises depth values of a plurality of samples within the depth prediction interval; and
determining the depth values represented by the sub-intervals according to the sample distribution data.

10. The electronic device of claim 9, wherein the preset division standard comprises:
for any sub-interval, a product of a depth range of the sub-interval and a quantity of samples distributed in the sub-interval conforms to a preset value range.

11. The electronic device of claim 9, wherein the instructions, when executed by the at least one processor, enable the at least one processor to further perform an operation of:
for any sub-interval, calculating an average value of depth values of samples distributed in the sub-interval, and determining the average value as the depth value represented by the sub-interval.

12. The electronic device of claim 8, wherein the instructions, when executed by the at least one processor, enable the at least one processor to further perform an operation of:
summing products of the distribution probabilities of the target object in the respective sub-intervals and the depth values represented by the respective sub-intervals, to obtain the depth value of the target object.

13. The electronic device of claim 8, wherein the instructions, when executed by the at least one processor, enable the at least one processor to further perform an operation of:
inputting the image to be detected into a pre-trained target detection model, and using a feature extraction layer of the target detection model to obtain the high-level semantic feature of the image to be detected.

14. An electronic device, comprising:
at least one processor; and
a memory communicatively connected with the at least one processor, wherein
the memory stores instructions executable by the at least one processor, and the instructions, when executed by the at least one processor, enable the at least one processor to perform the method of claim 7.

15. A non-transitory computer-readable storage medium storing computer instructions, wherein the computer instructions, when executed by a computer, cause the computer to perform the method of claim 1.

16. The non-transitory computer-readable storage medium of claim 15, wherein the computer instructions, when executed by the computer, cause the computer to further perform operations of:
dividing the depth prediction interval into a preset quantity of sub-intervals according to sample distribution data and a preset division standard, wherein the sample distribution data comprises depth values of a plurality of samples within the depth prediction interval; and
determining the depth values represented by the sub-intervals according to the sample distribution data.

17. The non-transitory computer-readable storage medium of claim 16, wherein the preset division standard comprises:
for any sub-interval, a product of a depth range of the sub-interval and a quantity of samples distributed in the sub-interval conforms to a preset value range.

18. The non-transitory computer-readable storage medium of claim 16, wherein the computer instructions, when executed by the computer, cause the computer to further perform an operation of:
for any sub-interval, calculating an average value of depth values of samples distributed in the sub-interval, and determining the average value as the depth value represented by the sub-interval.

19. The non-transitory computer-readable storage medium of claim 15, wherein the computer instructions, when executed by the computer, cause the computer to further perform an operation of:
summing products of the distribution probabilities of the target object in the respective sub-intervals and the depth values represented by the respective sub-intervals, to obtain the depth value of the target object.

20. A non-transitory computer-readable storage medium storing computer instructions, wherein the computer instructions, when executed by a computer, cause the computer to perform the method of claim 7.
